(19) United States
(12) Patent Application Publication
(10) Pub. No.: US 2025/0245517 A1
(43) Pub. Date: Jul. 31, 2025

(54) METHOD AND DEVICE WITH INCREMENTAL LEARNING

(71) Applicants: Samsung Electronics Co., Ltd., Suwon-si (KR); Seoul National University R&DB Foundation, Seoul (KR)

(72) Inventors: Taehoon KIM, Seoul (KR); Bohyung HAN, Seoul (KR); Donghwan JANG, Seoul (KR)

(73) Assignees: Samsung Electronics Co., Ltd., Suwon-si (KR); Seoul National University R&DB Foundation, Seoul (KR)

(21) Appl. No.: 19/018,929

(22) Filed: Jan. 13, 2025

(30) Foreign Application Priority Data
Jan. 26, 2024 (KR) 10-2024-0012563
Apr. 16, 2024 (KR) 10-2024-0050716

(51) Int. Cl. G06N 3/096

(52) U.S. Cl. CPC G06N 3/096

(57) ABSTRACT

A method and apparatus for incremental learning are provided. The method includes performing training of a model for a specific task, calculating an average value of a parameter of the model before training for the specific task and calculating a parameter of the model updated by performing training for the specific task, and changing a parameter of the model to the calculated average value.

### CROSS-REFERENCE TO RELATED APPLICATIONS

This application claims the benefit under 35 USC § 119 (a) of Korean Patent Application No. 10-2024-0012563, filed on Jan. 26, 2024, and Korean Patent Application No. 10-2024-0050716, filed on Apr. 16, 2024, in the Korean Intellectual Property Office, the entire disclosures of which are incorporated herein by reference for all purposes.

### BACKGROUND

### 1. Field

The following description relates to a method and apparatus with incremental learning.

### 2. Description of Related Art

Recently despite marked achievements of deep neural networks (DNNs), training a model in conditions of continuously changing data distributions may lead to an issue of catastrophic forgetting, that is, precipitously forgetting previously learned information due to new learning new information. Since environments in which DNNs are actually deployed often dynamically change over time, solving this issue is beneficial for improving the efficiency and general applicability of DNNs.

Incremental learning is a training method of solving the issue of catastrophic forgetting. Incremental learning prevents a model from forgetting previously trained information while learning new classes or information. Other methods for addressing the issue of forgetting previous training about previous tasks while learning a new task include knowledge distillation, architecture expansion, and parameter regularization.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples and embodiments described below may provide a training method for class incremental learning (CIL) that optimizes a model weight by manipulating the model weight in a parameter space. However, the technical aspects are not limited to the aforementioned aspects, and other technical aspects may be present.

In one general aspect, an incremental learning method performed by one or more processors includes: performing training of a model for a specific task; calculating an average value of a parameter of the model before the performing of the training for the specific task and calculating a parameter of the model updated by performing training for the specific task; changing a parameter of the model to the calculated average value; and inputting input data to the model with the changed parameter and generating, by the model with the changed parameter, an inference from the input data.

The performing of the training of the model for the specific task may include: based on a target epoch of training for the specific task, calculating an average value of a parameter of the model updated in an epoch before the target epoch and a parameter of the model updated by performing the target epoch; and changing a parameter of the model corresponding to the target epoch to the calculated average value.

The performing of the training of the model for the specific task may include: calculating an average value of a parameter of at least one checkpoint of the model in a training trajectory for training the model for the specific task; and changing the parameter of the model to the calculated average value of the at least one checkpoint of the model.

The calculating of the average value may include: based on an incremental learning operation of training the model, determining a weight of the parameter of the model before the training for the specific task; and based on the weight, calculating a weighted average value of the parameter of the model before the training for the specific task and of the parameter of the model as updated by performing the training for the specific task.

The performing of the training of the model for the specific task may include: based on determining that an amount of change in the parameter of the model exceeds a threshold value for each epoch of training for the specific task, adjusting the parameter so that the amount of change becomes smaller.

The performing of the training of the model for the specific task may include: based on an amount of change in the parameter exceeding a threshold value for each epoch of epochs for performing the training for the specific task, determining an adjustment index of the parameter based on a magnitude of the amount of change and the threshold value; and based on the adjustment index, changing the parameter.

The model may include a classification model configured to classify a class of input data, and the specific task may include a classification task for a class that the model has not been trained for prior to the performing of the training of the model for the specific task.

The model may include a feature extractor and a classifier, and wherein the calculating of the average value includes: generating an average value of a parameter of the feature extractor before the training for the specific task and generating a parameter of the feature extractor updated by performing the training for the specific task; and extracting a parameter corresponding to a newly trained class from among parameters of the classifier that are updated by performing the training for the specific task, and wherein the changing of the parameter of the model to the calculated average value includes: changing a parameter of the feature extractor to the calculated average value; and changing a parameter of the classifier to data in which the parameter of the classifier before the training for the specific task is connected to the extracted parameter.

The method may further include: in response to an incremental learning operation of the model, storing the parameter of the model.

The calculating of the average value may include obtaining, from a memory, the parameter of the model before the training for the specific task, the parameter of the model before the training of the specific task having been stored in the memory after training model for a previous specific task.

The model before the training for the specific task may include a model on which training for at least one task is performed.

A non-transitory computer-readable storage medium may store instructions that, when executed by a processor, cause the processor to perform any of the incremental learning methods.

In another general aspect, an apparatus for incrementally training a model includes: one or more processors configured to: perform training of the model for a specific task; calculate an average value of a parameter of the model before the performing of the training for the specific task and calculate a parameter of the model updated by performing training for the specific task; change a parameter of the model to the calculated average value; and input input data to the model with the changed parameter and generate, by the model with the changed parameter, an inference from the input data.

The apparatus may further include: a memory configured to store the parameter of the model.

The one or more processors may be further configured to: in performing training of the model for the specific task, based on a target epoch of training for the specific task, calculate an average value of a parameter of the model updated in an epoch before the target epoch and calculate a parameter of the model updated by performing the target epoch; and change a parameter of the model corresponding to the target epoch to the calculated average value.

The one or more processors may be further configured to: in calculating the average value, based on an incremental operation of the model, determine a weight of the parameter of the model before the training for the specific task; and based on the weight, calculate a weighted average value of the parameter of the model before the training for the specific task and calculate the parameter of the model updated by performing the training for the specific task.

The one or more processors may be further configured to: in performing training of the model for the specific task, in response to an amount of change in the parameter exceeding a threshold value for each epoch of a series of epochs of training for the specific task, determine an adjustment index of the parameter based on a magnitude of the amount of change and the threshold value; and based on the adjustment index, change the parameter.

The model may include a classification model configured to classify a class of input data, and the specific task includes a classification task for a class that the model has not been trained for prior to the performing of the training of the model for the specific task.

The model may include a feature extractor and a classifier, and the one or more processors may be further configured to: in calculating the average value, calculate an average value of a parameter of the feature extractor before training for the specific task and calculate a parameter of the feature extractor updated by performing the training for the specific task; and extract a parameter corresponding to a newly trained class from among parameters of the classifier updated by performing the training for the specific task, and in changing the parameter of the model to the calculated average value, change a parameter of the feature extractor to the calculated average value; and change a parameter of the classifier to data in which the parameter of the classifier before the training for the specific task is connected to the extracted parameter.

The model before the training for the specific task may include a model on which training for at least one task is performed.

Other features and aspects will be apparent from the following detailed description, the drawings, and the claims.

### BRIEF DESCRIPTION OF THE DRAWINGS

FIG. 1 illustrates an example of an incremental learning method, according to one or more embodiments.

FIGS. 2A and 2B illustrate an example of an inter-task weight merging operation, according to one or more embodiments.

FIG. 3 illustrates an example of an intra-task weight merging operation, according to one or more embodiments.

FIG. 4 illustrates an example of a bounded model update operation, according to one or more embodiments.

FIG. 5 illustrates an example of a defect detection model to which an incremental learning method is applied, according to one or more embodiments.

FIG. 6 illustrates an example configuration of an apparatus, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

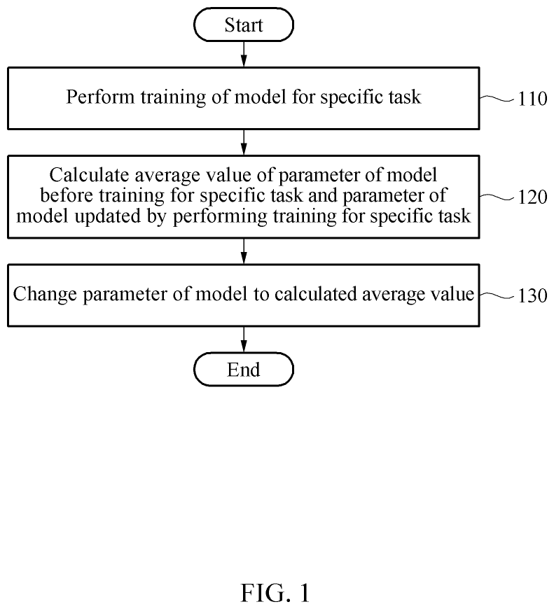

FIG. 1 illustrates an example of an incremental learning method, according to one or more embodiments.

Regarding terminology, the incremental learning method may correspond to one incremental operation (one increment/iteration). When the incremental learning method is performed for a k-th task of a neural network model, an incremental operation of the neural network model is a k-th incremental operation, and a parameter of the model determined by the incremental learning method is a parameter of the model determined at the k-th incremental operation. The parameter of the neural network model may be/include a weight of at least one layer included in the neural network model. The term neural network model is sometimes referred to herein as “model”.

Referring to FIG. 1, the incremental learning method may include operation 110 of performing training of a model for a specific task. Training for a specific task may involve training with a training data set corresponding to the specific task. A task may include a variety of constituent tasks that may be performed on a model being trained, a variety, for example, of classification tasks, of object detection tasks, of natural language processing tasks, or the like. Constituent tasks of a task for incremental learning may each be the same type of task. For example, a task for class incremental learning (CIL) (a type of incremental learning) may include constituent classification tasks including image data sets corresponding to respective classes. For example, a task for incremental learning in natural language processing may include constituent natural language processing tasks of respective natural language data sets of respective different languages.

The incremental learning method may include (i) operation 120 of calculating an average value of a parameter of the model before the training for the specific task (operation 110) and a parameter of the model updated by performing the training for the specific task (operation 110) and (ii) operation 130 of changing a parameter of the model (as trained in operation 110) to the calculated average value. The average value of the parameter of the model may be determined (or updated) at each incremental operation. Operations 120 to 130 may correspond to an inter-task weight merging operation described below.

The model before training for the specific task may include a model on which training for at least one task is performed. For example, when the specific task is the k-th task, the model before training for the specific task may correspond to a model that has completed training for a (k−1)-th task, and may be determined in a (k−1)-th incremental operation.

Operation 120 may include obtaining the parameter of the model as stored before the training for the specific task. The parameter of the model before the training for the specific task may be stored in memory within (or accessible from) an apparatus performing the incremental learning method. For example, when the specific task is the k-th task, a parameter of the model determined in the (k−1)-th incremental operation may be stored and serve as the parameter of the model before the training for the specific task. The average value of parameters of the model may be calculated (operation 120) based on (i) the aforementioned pre-stored parameter of the model as determined in the (k−1)-th incremental operation and (ii) the parameter of the model determined by the training for the k-th task.

Operation 120 of calculating the average value of the parameter may include, (i) based on an incremental operation of the model, determining a weight of the parameter of the model before the training for the specific task (here “weight” is a weight for averaging, not a weight (e.g., of a node) of the model), and (ii) based on the determined weight, calculating a weighted average value of (i) the parameter of the model before the training for the specific task (see first term of Equation 1) and (ii) the parameter of the model as updated by performing the training (operation 110) for the specific task (see second term of Equation 1). For example, when the specific task is the k-th task, a weight of the parameter of the model before the training for the specific task may be determined to be k−1. For example, when the parameter of the model before the training for the specific task is θₖ^{base}, (“base” indicating “before training”) the parameter of the model immediately after being updated by performing the training for the k-th specific task (for the k-th incremental operation) is θₖ (θₖ is a direct training result that has not been averaged), and the parameter changed to the weighted average (operation 130), referred to as θₖ₊₁^{base}, may be determined as in Equation 1.

$${θ}_{k + 1}^{base} = \frac{k - 1}{k} \cdot {θ}_{k}^{base} + \frac{1}{k} \cdot {θ}_{k} \qquad Equation 1$$

Operation 110 of performing training of the model for the specific task according to an example may include an intra-task weight merging operation described below. As an example of the intra-task weight merging operation, operation 110 of performing training of the model for the specific task may include calculating an average value of a parameter of at least one checkpoint in a training trajectory for the specific task and changing the parameter of the model to the calculated average value. A checkpoint is data that stores the parameter of the model at a specific point in time (or an epoch) during the training process of the model. The parameter of the model may be changed to the average value of the parameter of checkpoints corresponding to different points in time during the training process.

As an example of the intra-task weight merging operation, operation 110 of performing training of the model for the specific task may include, in response to a target epoch of training for the specific task, calculating an average value of a parameter of the model updated in an epoch before the target epoch and a parameter of the model updated by performing the target epoch and changing a parameter of the model corresponding to the target epoch to the calculated average value. For example, when the target epoch of training for the k-th task is an (n+1)-th epoch, denoting the parameter of the model updated in the epoch before the target epoch (the n-th epoch) as Θₖ^{avg} (see right side of Equation 2), and denoting the parameter of the model updated by performing the target epoch as Θₖ, the parameter of the model corresponding to the target epoch is denoted as Θₖ^{avg} (new/updated, see left side of Equation 2), which may be determined/updated as shown in Equation 2.

$${Θ}_{k}^{avg} ← \frac{n \cdot {Θ}_{k}^{avg} + {Θ}_{k}}{n + 1} \qquad Equation 2$$

Operation 110 of performing training of the model for the specific task may include a bounded model update operation described below. As an example of the bounded model update operation, operation 110 of performing training of the model for the specific task may include, when the amount of change in the parameter of the model exceeds a threshold value for each epoch of training for the specific task, adjusting the parameter of the model so that the amount of change becomes small. The amount of change in the parameter of the model is the degree to which (i) the parameter of the model determined in a current epoch is changed, as compared to (ii) the parameter of the model before training for the specific task is performed. The amount of change in the parameter of the model may be determined by the difference between the parameter of the model determined in the current epoch and the parameter of the model as it was before the training for the specific task is performed.

As an example of the bounded model update operation, operation 110 of performing training of the model for the specific task may include, when the amount of change in the parameter exceeds a threshold value for each epoch of the training for the specific task, determining an adjustment index of the parameter based on (i) the magnitude of the amount of change and (ii) the threshold value, and based on the adjustment index, changing the parameter. For example, denoting the amount of change in the parameter as ΔΘ and denoting the threshold value as B, the adjustment index may be determined as B/∥ΔΘ∥, and the amount of change in the parameter of the model (ΔΘ) may be adjusted as shown in Equation 3.

$$ΔΘ ← \{ \begin{matrix}B \cdot \frac{ΔΘ}{‖ ΔΘ ‖} , & if ‖ ΔΘ ‖ > B \\ ΔΘ , & otherwise\end{matrix} \qquad Equation 3$$

The parameter of the model corresponding to the current epoch may be determined based on the amount of change in the parameter, where the amount of change is adjusted by Equation 3. For example, the parameter of the model corresponding to the current epoch may be determined by adding ΔΘ to the value of the parameter of the model as determined in a previous epoch.

The incremental learning method may include storing the parameter of the model in response to an incremental operation of the model. The parameter of the model changed to the calculated average value may be stored for inference or training in a next incremental operation. For example, the parameter of the model obtained by the k-th incremental operation may be stored with data indicating (or associated with) the k-th incremental operation. For example, the parameter of the model obtained by the k-th incremental operation may be stored together with a k value (k serving as an index).

The model may be, as a non-limiting example, a classification model for determining a class of input data (i.e., classifying the input data). For example, the model may include a feature extractor and a classifier. In this example, the specific task may be a classification task for a class for which the model has not been trained. The incremental learning method may include a training method for CIL.

For example, operation 120 of calculating the average value for CIL may include (i) calculating an average value of a parameter of the feature extractor before training for the specific task and calculating a parameter of the feature extractor updated by performing training for the specific task, and (ii) extracting a parameter corresponding to a newly trained class from among parameters of the classifier that are updated by performing the training for the specific task. This is described in detail below.

For example, operation 130 of changing the parameter of the model for CIL to the calculated average value may include changing a parameter of the feature extractor to the calculated average value and changing a parameter of the classifier to data in which the parameter of the classifier before training for the specific task is connected to the extracted parameter. This is described in detail below.

The training method for CIL may be referred to as merge-and-bound (M&B).

M&B may include an inter-task weight merging operation and an intra-task weight

merging operation. Inter-task weight merging may involve integrating previous models (i.e., previous versions of the subject model) by averaging parameters (e.g., node weights) of the model in a previous operation in order to preserve all (or most) knowledge obtained up to a current task. Through the inter-task weight merging, a base model may be formed by averaging parameters of the model trained in an individual incremental operation. The base model may be used as an initialization point for a subsequent task.

Intra-task weight merging may facilitate training of the current task by combining parameters of the model within the current operation to improve adaptability to a new task (while reducing the chance of catastrophic forgetting). By averaging multiple checkpoints along the training trajectory within the current task, generalization ability of the model for a new task may be improved.

In addition, M&B may include the bounded model update operation. The bounded model update operation may be an update operation of the parameter of the model and may optimize a target model with minimal cumulative updates while preserving knowledge from a previous task. The bounded model update operation may restrict a weight-to-be-updated to stay near a parameter value of the base model when training the model on each task. By ensuring that a value of the updated parameter of the model does not excessively deviate from the base model, knowledge from the previous task may be preserved.

CIL is a method of training a model in which the number of classes increases for each operation without forgetting previously trained classes (i.e., new classes are learned without the intent of forgetting previously learned classes). The CIL according to one or more embodiments may include a training framework for processing a series of tasks T_{1:K}={T₁, . . . , Tₖ, . . . , T_{K}}. Each task Tₖ may include a respective labeled training data set Dₖ, and the label set Cₖ of the labeled training data set Dₖ may not overlap with the label sets defined in the past. In other words, (C₁∪ . . . ∪Cₖ₋₁)∪Cₖ=Ø. In the k-th incremental operation, a current model Mₖ(•) may be trained on an integrated dataset D′ₖ=Dₖ∪Bₖ₋₁. Bₖ₋₁ is a memory buffer for storing representative examples included in all previously trained classes.

The inter-task weight merging may build a comprehensive model by combining trained knowledge from all (or most) previously trained tasks and calculating an average of previous models. On the other hand, the intra-task weight merging may be effective in improving the generalization ability of the model to a new task. This may be achieved by averaging weights of the model at various checkpoints along the training trajectories. In both inter-task weight merging and intra-task weight merging, since averaging of models is performed online, there is no need to store/retain all models that are contributing to an averaging.

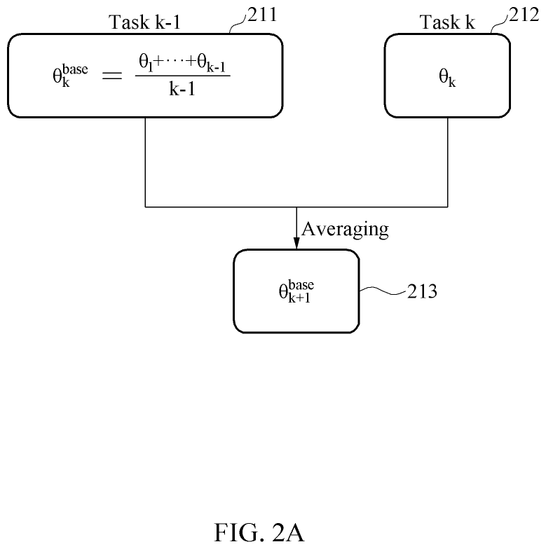

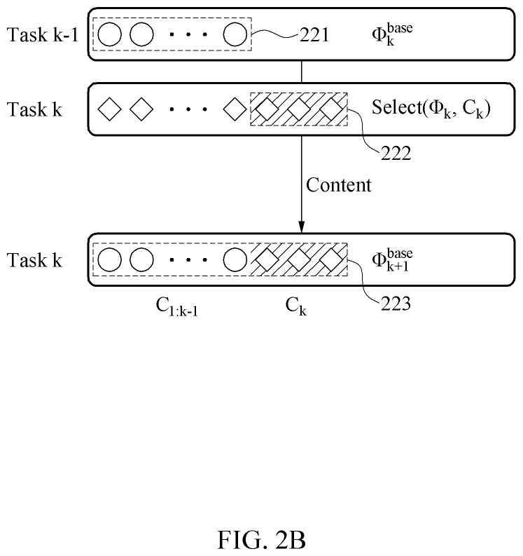

FIGS. 2A and 2B illustrate an example of an inter-task weight merging operation, according to one or more embodiments.

Models (or, sub-models) trained from a previous task may be merged into a base model Mₖ^{base}(•) to integrate previously trained knowledge. The base model Mₖ^{base}(•) may be a model before a k-th task is trained. For example, the base model Mₖ^{base}(•) may include a feature extractor f_{θ}_{ₖ}_{^{base}}(•) and a classifier g_{φ}_{ₖ}_{^{base}}(•). And, the feature extractor f_{θ}_{ₖ}_{^{base}}(•) and classifier g_{φ}_{ₖ}_{^{base}}(•) may be parameterized by Θₖ^{base}={θₖ^{base}, φₖ^{base}}. As a non-limiting example, the feature extractor may be the convolutional part of a convolutional neural network (CNN), and the classifier may be a fully connected network part of the CNN.

When a k-th incremental operation has completed, a current feature extractor f_{θ}_{ₖ}(•) and a current classifier g_{φ}_{ₖ}(•) may be combined with the current base model Mₖ^{base}(•). This process may generate a new base model Mₖ₊₁^{base}(•) for the next incremental operation. A parameter θₖ₊₁^{base} of a new feature extractor f_{θ}_{ₖ₊₁}(•) may be obtained through a moving average of parameters of feature extractors of all models, as shown in Equation 1.

Referring to FIG. 2A, a parameter θₖ₊₁^{base} 213 may be determined as a moving average of parameters of all previous feature extractors, θ₁, θ₂, . . . , θₖ to obtain a feature extractor f_{θ}_{ₖ₊₁}_{^{base}}(•). This may be calculated in a recursive manner using θₖ^{base} 211 and θₖ 212, as shown in Equation 1. θₖ^{base} 211 may correspond to a parameter of the feature extractor f_{θ}_{ₖ}_{^{base}}(•) included in the base model Mₖ^{base}(•) as it was before training for the k-th task is performed, that is, the base model obtained from a (k−1)-th incremental operation.

Referring to FIG. 2B, in order to obtain a parameter φₖ₊₁^{base} 223 of a classifier g_{φ}_{ₖ₊₁}_{^{base}} (•), a parameter 222 of the current classifier related to a class included in a current task Cₖ may be concatenated with a parameter φₖ^{base} 221 of a classifier of a current base model. As shown in Equation 4, to obtain a classifier of a new base model of a (k+1)-th operation, the classifier g_{φ}_{ₖ}_{^{base}}(•) of the current base model defined as classes in Cₖ₋₁ may be concatenated with a weight corresponding to a Cₖ class of the current classifier g_{φ}_{ₖ}(•).

$${ϕ}_{k + 1}^{base} = Concat ( {ϕ}_{k}^{base} , Select ( {ϕ}_{k} , {C}_{k} ) ) \qquad Equation 4$$

In Equation 4, Select(φₖ, Cₖ) is a function that extracts a parameter corresponding to the Cₖ class of the current classifier g_{φ}_{ₖ}(•).

In a (k+1)-th incremental operation, training of the base model Mₖ₊₁^{base}(•) including all/most knowledge trained up to a current operation may be started.

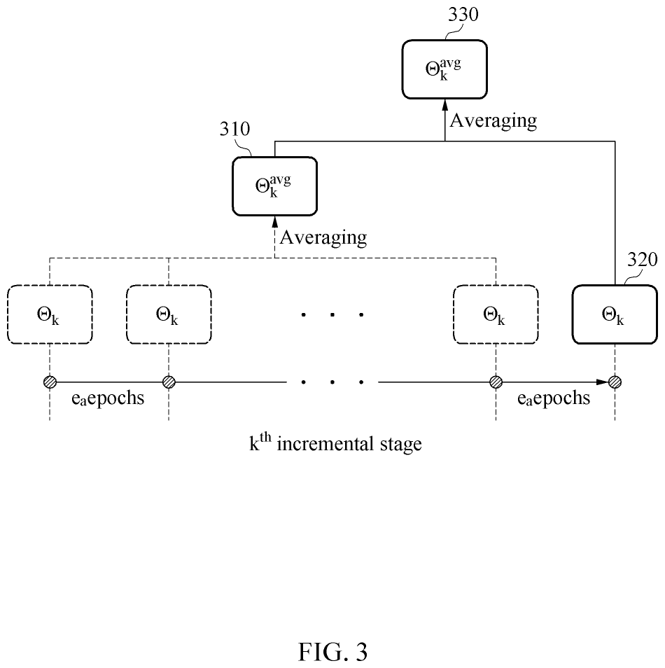

FIG. 3 illustrates an example of an intra-task weight merging operation, according to one or more embodiments.

Referring to FIG. 3, for intra-task weight merging, generalization ability of a model for a current task may be improved by averaging multiple checkpoints along training trajectories. In a k-th incremental operation, a model Mₖ^{avg}(•) merged within a task that is parameterized by Θₖ^{avg} 310 may be updated for each epoch eₐ, as shown in Equation 2. In other words, Θₖ^{avg} 330 updated to an average of Θₖ^{avg} 310 and a parameter ηₖ 320 of a model updated by performing a target epoch may be obtained.

When the k-th incremental operation has completed, a final model Mₖ(•) may be replaced (Θₖ←Θₖ^{avg} 330) with the model Mₖ^{avg}(•) merged within a task. This model Mₖ^{avg}(•), after the replacing, may be used for inference, and may also be used for the calculation of the base model Mₖ₊₁^{base}(•) when a next incremental operation is performed.

In the case of a model equipped with batch normalization (BN), an additional data pass might be required after training to calculate an average and a variance, which are new running estimates of activation after merging models. This is because accumulated BN statistics are not calculated for merged models. An additional forward path may be performed in which execution statistics of the current model Mₖ(•) are estimated before model merging. Accordingly, bias in the current task due to lack of samples of classes introduced in a previous task may be alleviated.

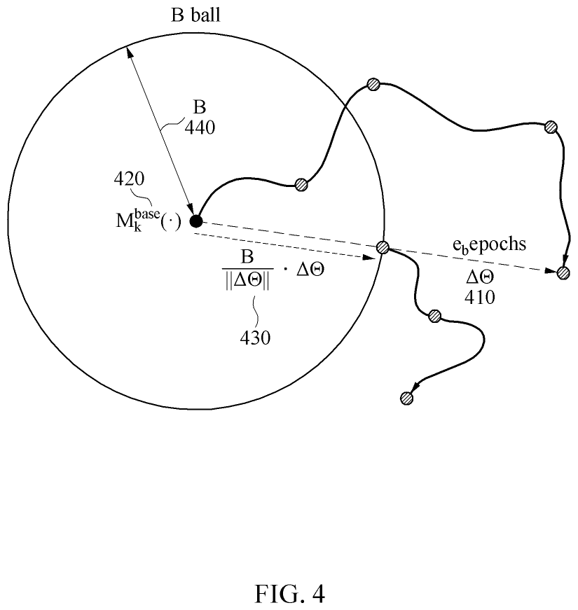

FIG. 4 illustrates an example of a bounded model update operation, according to one or more embodiments.

Referring to FIG. 4, constraints on model update may be applied in CIL. As shown in Equation 3, the degree of weight update from a base model may be limited for each epoch e_{b}.

ΔΘ 410 represents the degree to which a current model deviates from a base model Mₖ^{base}(•) 420 and B 440 is a threshold value to limit a gradient size. As shown in Equation 3, when the ΔΘ 410 exceeds B 440, the ΔΘ 410 may be adjusted to B/∥ΔΘ∥·ΔΘ 430.

A bounded model update may be performed in an incremental operation with intra-task weight merging. Assuming that the base model has knowledge from previous tasks, the bounded model update may prevent a model update in the current task from deviating significantly from the base model in a weight space, thereby preventing excessive loss of previously trained information.

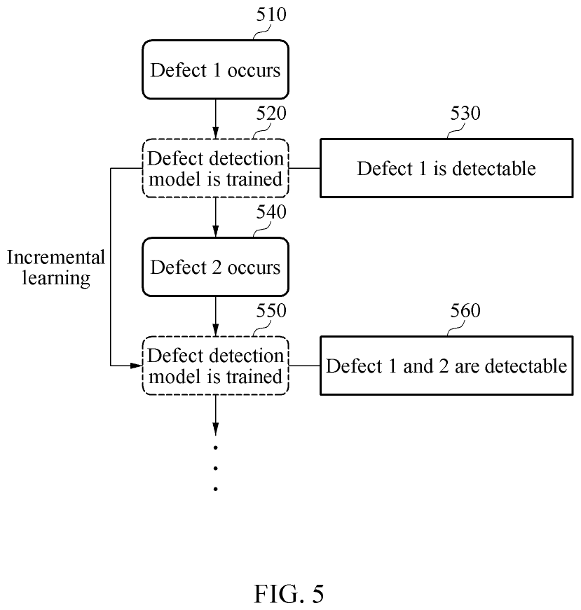

FIG. 5 illustrates an example of a defect detection model to which an incremental learning method is applied, according to one or more embodiments.

Referring to FIG. 5, when a first type of defect occurs in operation 510, in operation 520 a defect detection model may be trained based on a first type of defect data. In operation 530, the trained defect detection model may detect the first type of defect.

When a second type of defect occurs in operation 540, then in operation 550 the defect detection model may be trained based on a second type of defect data through any of the incremental learning techniques described above. The defect detection model trained through any of the incremental learning techniques may detect the first type of defect and the second type of defect, in operation 560.

When a new type of defect occurs, the defect detection model may be trained to detect the new type of defect in addition to previously trained types of defects through the incremental learning method based on defect data of a new type of defect. Through the incremental learning method, a defect data of a new defect type may be trained while maintaining information for detecting types of defects that were previously trained for.

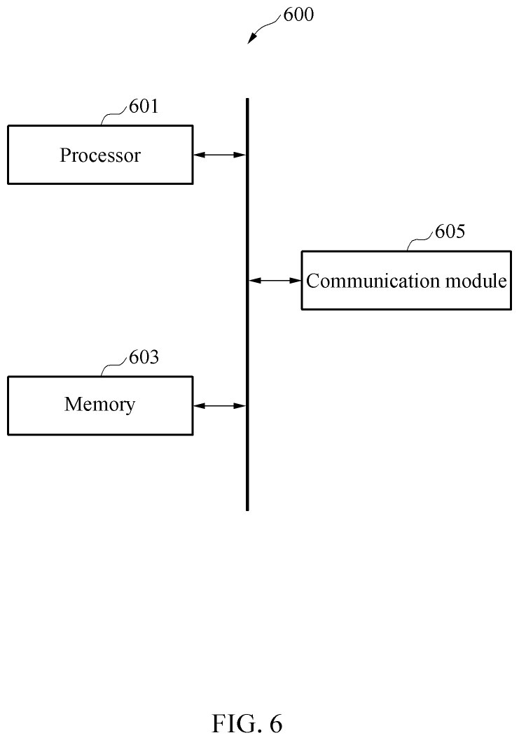

FIG. 6 illustrates an example of a configuration of an apparatus, according to one or more embodiments.

Referring to FIG. 6, an apparatus 600 according to one or more embodiments may include a processor 601, a memory 603, and a communication module 605. The apparatus 600 according to an example may be an apparatus for incrementally training a model, and may include an apparatus for performing the incremental learning method described above with reference to FIGS. 1 to 5.

The processor 601 may perform at least one operation of the incremental learning method described above with reference to FIGS. 1 to 5. For example, the processor 601 may perform at least one of performing training of a model for a specific task, calculating an average value of a parameter of a model before training for the specific task and a parameter of a model updated by performing training for the specific task, and changing a parameter of the model to the calculated average value. The processor 601 may be a combination of processors, possibly of different types.

The memory 603 may be a volatile or non-volatile memory (but not a signal per se) and may store data related to the incremental learning method described above with reference to FIGS. 1 to 5. For example, the memory 603 may store data generated during the process of performing the incremental learning method or data necessary for performing the incremental learning method. For example, the memory 603 may store the parameter of the model.

The communication module 605 according to an example may provide a function for the apparatus 600 to communicate with another electronic device or another server through a network. In other words, the apparatus 600 may be connected to an external device (e.g., a terminal of a user, a server, or a network) through the communication module 605 and may exchange data with the external device.

The memory 603 may not be a component of the apparatus 600 and may be included in an external device accessible by the apparatus 600. In this case, the apparatus 600 may receive data stored in the memory 603 included in the external device and transmit data to be stored in the memory 603 through the communication module 605.

The memory 603 may store a program configured to implement the incremental learning method described above with reference to FIGS. 1 to 5. The processor 601 may execute a program stored in the memory 603 and may control the device 600. Code from the program executed by the processor 601 may be stored in the memory 603.

The apparatus 600 may further include other components not shown in the drawings. For example, the apparatus 600 may further include an input/output interface including an input device and an output device as the means of interfacing with the communication module 605. In addition, for example, the apparatus 600 may further include other components, such as a transceiver, various sensors, or a database.

The examples described herein may be implemented by using a hardware component, a software component, and/or a combination thereof. A processing device (e.g., the processor 601) may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The computing apparatuses, the electronic devices, the processors, the memories, the displays, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An incremental learning method performed by one or more processors, the method comprising:
performing training of a model for a specific task;
calculating an average value of a parameter of the model before the performing of the training for the specific task and calculating a parameter of the model updated by performing training for the specific task;
changing a parameter of the model to the calculated average value; and
inputting input data to the model with the changed parameter and generating, by the model with the changed parameter, an inference from the input data.

2. The incremental learning method of claim 1, wherein the performing of the training of the model for the specific task comprises:
based on a target epoch of training for the specific task, calculating an average value of a parameter of the model updated in an epoch before the target epoch and a parameter of the model updated by performing the target epoch; and
changing a parameter of the model corresponding to the target epoch to the calculated average value.

3. The incremental learning method of claim 1, wherein the performing of the training of the model for the specific task comprises:
calculating an average value of a parameter of at least one checkpoint of the model in a training trajectory for training the model for the specific task; and
changing the parameter of the model to the calculated average value of the at least one checkpoint of the model.

4. The incremental learning method of claim 1, wherein the calculating of the average value comprises:
based on an incremental learning operation of training the model, determining a weight of the parameter of the model before the training for the specific task; and
based on the weight, calculating a weighted average value of the parameter of the model before the training for the specific task and of the parameter of the model as updated by performing the training for the specific task.

5. The incremental learning method of claim 1, wherein the performing of the training of the model for the specific task comprises:
based on determining that an amount of change in the parameter of the model exceeds a threshold value for each epoch of training for the specific task, adjusting the parameter so that the amount of change becomes smaller.

6. The incremental learning method of claim 1, wherein the performing of the training of the model for the specific task comprises:
based on an amount of change in the parameter exceeding a threshold value for each epoch of epochs for performing the training for the specific task, determining an adjustment index of the parameter based on a magnitude of the amount of change and the threshold value; and
based on the adjustment index, changing the parameter.

7. The incremental learning method of claim 1, wherein
the model includes a classification model configured to classify a class of input data, and
the specific task includes a classification task for a class that the model has not been trained for prior to the performing of the training of the model for the specific task.

8. The incremental learning method of claim 1, wherein the model includes a feature extractor and a classifier, and wherein the calculating of the average value comprises:
generating an average value of a parameter of the feature extractor before the training for the specific task and generating a parameter of the feature extractor updated by performing the training for the specific task; and
extracting a parameter corresponding to a newly trained class from among parameters of the classifier that are updated by performing the training for the specific task, and
wherein the changing of the parameter of the model to the calculated average value comprises:
changing a parameter of the feature extractor to the calculated average value; and
changing a parameter of the classifier to data in which the parameter of the classifier before the training for the specific task is connected to the extracted parameter.

9. The incremental learning method of claim 1, further comprising:
in response to an incremental learning operation of the model, storing the parameter of the model.

10. The incremental learning method of claim 1, wherein the calculating of the average value comprises obtaining, from a memory, the parameter of the model before the training for the specific task, the parameter of the model before the training of the specific task having been stored in the memory after training model for a previous specific task.

11. The incremental learning method of claim 1, wherein the model before the training for the specific task comprises a model on which training for at least one task is performed.

12. A non-transitory computer-readable storage medium storing instructions that, when executed by a processor, cause the processor to perform the incremental learning method of claim 1.

13. An apparatus for incrementally training a model, the apparatus comprising:
one or more processors configured to:
perform training of the model for a specific task;
calculate an average value of a parameter of the model before the performing of the training for the specific task and calculate a parameter of the model updated by performing training for the specific task;
change a parameter of the model to the calculated average value; and
input input data to the model with the changed parameter and generate, by the model with the changed parameter, an inference from the input data.

14. The apparatus of claim 13, further comprising:
a memory configured to store the parameter of the model.

15. The apparatus of claim 13, wherein the one or more processors are further configured to:
in performing training of the model for the specific task,
based on a target epoch of training for the specific task, calculate an average value of a parameter of the model updated in an epoch before the target epoch and calculate a parameter of the model updated by performing the target epoch; and
change a parameter of the model corresponding to the target epoch to the calculated average value.

16. The apparatus of claim 13, wherein the one or more processors are further configured to:
in calculating the average value,
based on an incremental operation of the model, determine a weight of the parameter of the model before the training for the specific task; and
based on the weight, calculate a weighted average value of the parameter of the model before the training for the specific task and calculate the parameter of the model updated by performing the training for the specific task.

17. The apparatus of claim 13, wherein the one or more processors are further configured to:
in performing training of the model for the specific task,
in response to an amount of change in the parameter exceeding a threshold value for each epoch of a series of epochs of training for the specific task, determine an adjustment index of the parameter based on a magnitude of the amount of change and the threshold value; and
based on the adjustment index, change the parameter.

18. The apparatus of claim 13, wherein
the model includes a classification model configured classify a class of input data, and
the specific task includes a classification task for a class that the model has not been trained for prior to the performing of the training of the model for the specific task.

19. The apparatus of claim 13, wherein the model includes a feature extractor and a classifier, and the one or more processors are further configured to:
in calculating the average value,
calculate an average value of a parameter of the feature extractor before training for the specific task and calculate a parameter of the feature extractor updated by performing the training for the specific task; and
extract a parameter corresponding to a newly trained class from among parameters of the classifier updated by performing the training for the specific task, and
in changing the parameter of the model to the calculated average value,
change a parameter of the feature extractor to the calculated average value; and
change a parameter of the classifier to data in which the parameter of the classifier before the training for the specific task is connected to the extracted parameter.

20. The apparatus of claim 13, wherein the model before the training for the specific task comprises a model on which training for at least one task is performed.
